(19) United States
(12) Patent Application Publication
(10) Pub. No.: US 2018/0063333 A1
(43) Pub. Date: Mar. 1, 2018

(54) CALL CLASSIFICATION AND ROUTING USING ENUM QUERIES

(71) Applicant: T-Mobile USA, Inc., Bellevue, WA (US)

(72) Inventors: Robert Ara Kondakjian, Snohomish, WA (US); Robert F. Piscopo, JR., Bellevue, WA (US)

(21) Appl. No.: 15/384,185

(22) Filed: Dec. 19, 2016

Related U.S. Application Data
(60) Provisional application No. 62/380,833, filed on Aug. 29, 2016.

(51) Int. Cl. H04M 7/00; H04L 29/12; H04L 29/06

(52) U.S. Cl. CPC H04M 7/0075; H04L 61/308; H04L 61/1511; H04M 2203/158; H04L 69/169; H04L 65/1046; H04L 65/1006

(57) ABSTRACT

Systems and methods for classifying and routing an inbound call using ENUM queries are described. When a calling party initiates an inbound call, an Interconnect Session Border Controller (I-SBC) may generates a query for a calling party number (CgPN) and a called party number (CdPN) to search the inbound call in an E.164 Number to URI Mapping (ENUM) database. The I-SBC may check the CgPN against the ENUM database and identify a service provider identification (SPID) number associated with the classification of the CgPN found in the ENUM database. The I-SBC may then tag the SPID and an associated predetermined description to the inbound call, and route the inbound call based on the SPID.

### CROSS-REFERENCE TO RELATED APPLICATIONS

This application is a non-provisional of, and claims priority to and the benefit of, U.S. Provisional Patent Application Ser. No. 62/380,833, filed Aug. 29, 2016 and entitled “SIP CALL ROUTING USING CONCATENATED CALLING AND CALLED PARTY ADDRESSES IN ENUM QUERIES,” the entirety of which is incorporated herein by reference.

### BACKGROUND

Modern telecommunication systems include heterogeneous mixtures of second, third, and fourth generation (2G, 3G, and 4G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. Some of mobile devices operating in such telecommunication systems are also capable of operating over Wi-Fi networks for voice, also known as Voice-over-IP (VoIP) and data.

A user of such a mobile device may occasionally receive a call from an unknown caller, which may turn out be an unwanted call such as a sales, telemarketing, robo-call, spam, and the like. Even if the user had subscribed to a call ID service, seeing an unknown telephone number does not help the user to (consciously, effectively, knowingly, purposely, intentionally) decide to answer or dismiss the call. The user may be able to create his own list of blocked numbers, however, he would still need to initially answer the unknown call to decide whether to add the unknown number to the blocked number list to avoid future calls.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example block diagram of a system for classifying and routing an inbound call using ENUM queries.

FIG. 2 illustrates an example ENUM database.

FIG. 3 illustrates an example process for classifying and routing an inbound call using ENUM queries.

FIG. 4 illustrates an example process detailing some of the blocks of FIG. 3.

FIG. 5 illustrates an example process detailing one of the blocks of FIG. 3.

### DETAILED DESCRIPTION

Systems and methods discussed herein are directed to a service provided by a network for subscribers of the network for receiving additional information regarding incoming calls. Examples may include a system and a method for classifying and routing an inbound call using ENUM queries.

When a calling party initiates an inbound call, such as a voice over Internet Protocol (VoIP) call, the Session Initiation Protocol (SIP) may be utilized and an INVITE message may be routed from a SIP Peer to an Interconnect Session Border Controller (I-SBC). The INVITE message may include inbound call information such as a Calling Party Number (CgPN) and Called Party Number (CdPN) which may be telephone numbers and/or addresses in the Domain Name System (DNS). The I-SBC may then generate a query for the CgPN and CdPN to search the inbound call in an E.164 Number to URI Mapping (ENUM) database. The ENUM database may maintain various classifications, such as normal, spam, sale, marketing, scam, and the like, for phone numbers, E.164 addresses, and/or DNS addresses. The ENUM database may be maintained by a third party whose service is to collect information about known/suspected phone numbers for spam, scam, marketing, sales, etc., and compile the information. The user may provide a feedback to third party or to the ENUM database to enhance the classification of the received call, for example, a new, previously unidentified spam call.

The I-SBC may check the CgPN against the ENUM database and identify a service provider identification (SPID) number associated with the classification of the CgPN found in the ENUM database. The I-SBC may tag the SPID and an associated predetermined description, and route the inbound call based on the SPID. Depending on the SPID, the I-SBC may forward the inbound call to a called party of the inbound call without any revision, a normal call for example, or with a notice that the inbound call may be a spam. The I-SBC may block the inbound call for the inbound call identified as a known spam.

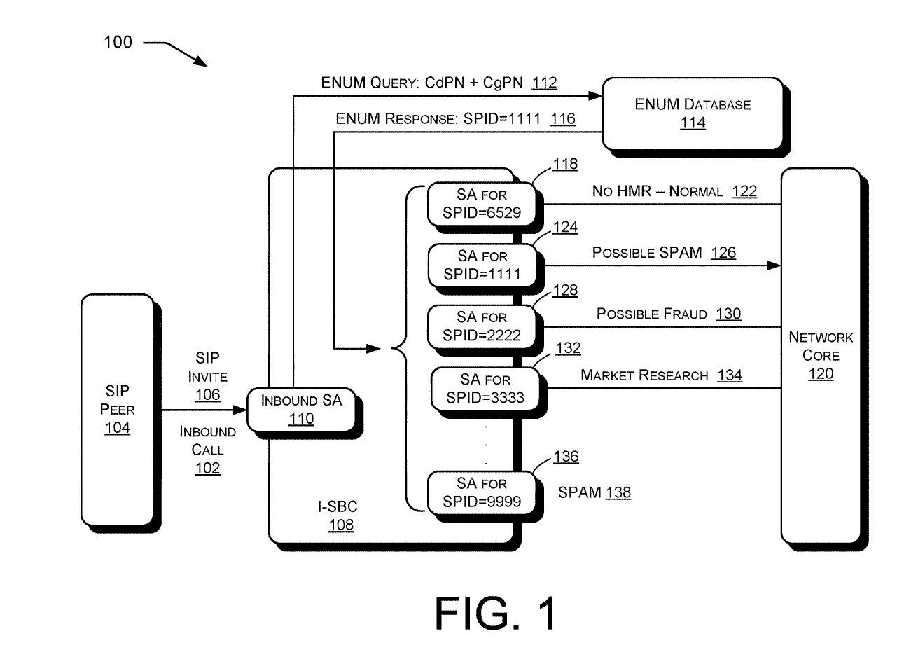

FIG. 1 illustrates an example block diagram 100 of a system for classifying and routing an inbound call using ENUM queries. As a calling party initiates a call, an inbound call 102, a SIP Peer 104 may send an INVITE 106 to an I-SBC 108, where an inbound session agent (SA) 110 may cause the I-SBC 106 to generate an ENUM query 112. The ENUM query 112 may comprise a CdPN query and CgPN query, which may be concatenated into one query. The I-SBC 108 may look up information included in the ENUM query 112 in an ENUM database 114, and generate an ENUM response 116. The I-SBC 108 may evaluate the CdPN query to determine if the called party were a subscriber to a service for classifying and routing an inbound call using ENUM queries before determining whether to generate the ENUM response 116.

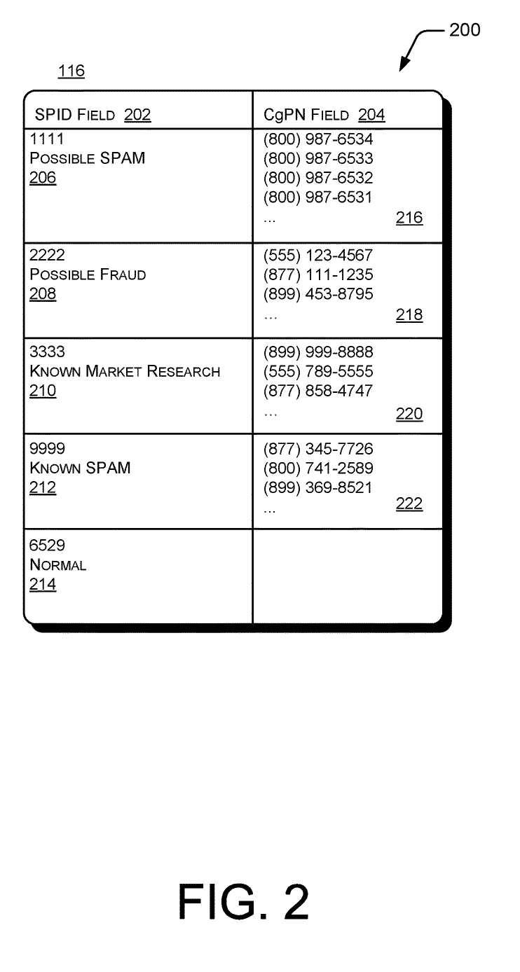

FIG. 2 illustrates an example embodiment 200 of the ENUM database 116. The ENUM database 116 may comprise an SPID field 202 and a CgPN field 204. Instead of valid SPIDs associated with normal calls, the SPID field 202 lists a plurality of fake SPIDs corresponding various categories, such as 1111 for possible SPAM 206, 2222 for possible fraud 208, 3333 for known market research 210, 9999 for known SPAM 201, and the like. Under each SPID, associated CgPN information may be listed. The CgPN information may include phone numbers, E.164 addresses, SIP address, or results from a DNS look-up based on the E.164 entries. In this example, four sets of 10-digit phone numbers, possible SPAM numbers 216, possible fraud numbers 218, known market research numbers 220, and known SPAM numbers 222 are illustrated. Because the ENUM database 116 only maintains CgPN information of undesired nature, if the CgPN information of the inbound call 102 were not found in the ENUM database 116, the inbound call 102 may be considered normal, and be assigned a specific SPID, 6529 for normal call 214 for example, indicating the inbound call 102 is a normal call.

The ENUM database 114 may be maintained and updated by a third party, and may accept feedback from users. A reporting solution may be utilized to track numbers of blocked and/or tagged calls, reasons for blocking certain calls or phone numbers, frequency of calls from the same calling party, and the like. Such reports may be sent via email to the third party maintaining the ENUM database 114 and to a network carrier employing the ENUM database 114. Based on the report, the ENUM database 114 may be updated near real-time. The ENUM database 114 may also be supplemented by obtaining similar listings and classifications of phone numbers offered by services other than the third party.

Referring back to FIG. 1, if the inbound call 102 were from (800) 987-6534, the I-SBC would generate the ENUM query 112 including this number, search for this number in the ENUM database 114, find it in the possible SPAM numbers 216, and return the ENUM response 116 with the SPID of 1111 from the Possible SPAM 206 as described in FIG. 2. Alternatively, the SIP INVITE 106 may be sent to an analytics engine associated with the ENUM database 114 for a pattern matching and/or recognition for the inbound call 102, and a result may be used to update the ENUM database 114.

At the I-SBC 108, an SA may route the inbound call 102 based on the SPID provided in the ENUM response 116 specific to the SPID. The SA may apply a header manipulation rule (HMR) to add a description associated with the SPID to the inbound call 102. The added description may be visible at the called party of the inbound call 102, and may provide a notice or warning regarding the nature of the inbound call 102. Five example SAs are illustrated in FIG. 1. The SA 118 for SPID=6529 is for a normal call as indicated by the SPID value of 6529 as discussed above with reference to FIG. 2, and may route the call to the network core 120 with no HMR application 122. The SA 124 for SPID=1111 is for a call indicated as a possible SPAM, such as the inbound call 102, as discussed above. The SA 124 may apply the HMR to add a description associated with the SPID of 1111, such as “Possible SPAM” 126, to the inbound call 102, and route the inbound call 102 to the network core 120. The SA 128 for SPID=2222 is for a call indicated as a possible fraud as discussed above. The SA 128 may apply the HMR to add a description associated with the SPID of 2222, such as “Possible Fraud” 130, to the call, and route the call to the network core 120. The SA 132 for SPID=3333 is for a call indicated as a known market research as discussed above. The SA 132 may apply the HMR to add a description associated with the SPID of, such as “Market Research” 134, to the call, and route the call to the network core 120. The SA 136 for SPID=9999 is for a call indicated as a known SPAM as discussed above. The SA 136 may apply the HMR to add a description associated with the SPID of, such as “SPAM” 138, to the call, and route the call to the network core 120. Alternatively, the SA 136 may block the call identified as SPAM with the SPID of 9999, terminate the call, or send a response, such as “undeliverable,” to the calling party.

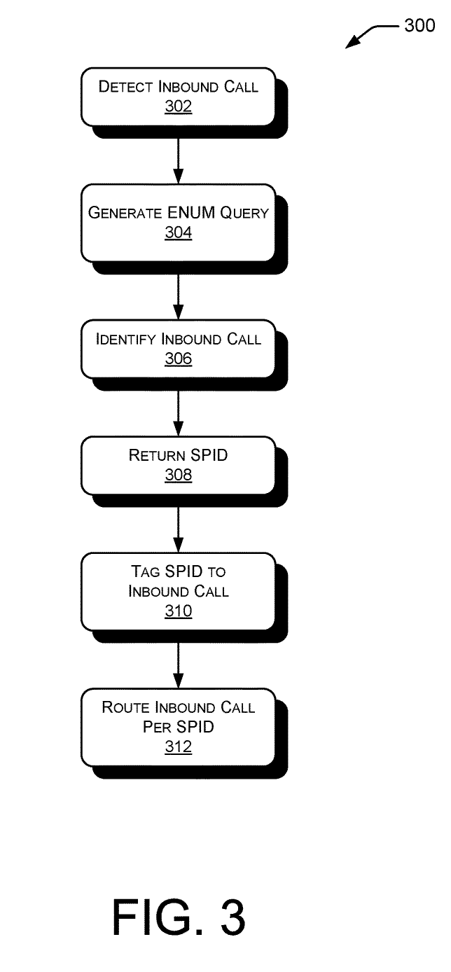

FIG. 3 illustrates an example process for 300 classifying and routing an inbound call using ENUM queries. In block 302, an inbound call, such as the inbound call 102 as discussed above with reference to FIG. 1, may be detected. In response to detecting the in inbound call, an ENUM query may be generated in block 304. The ENUM query may comprise a CdPN query and CgPN query, which may be concatenated into one query, as discussed above with reference to the ENUM query 112 in FIG. 1. In block 306, the I-SBC 108 may identify the inbound call based on the query and an ENUM database, such as the ENUM database 114, and return an SPID for the inbound call in block 308. The SPID is tagged to the inbound call in block 310, and the inbound call is routed according to a predefined process associated with the SPID in block 312.

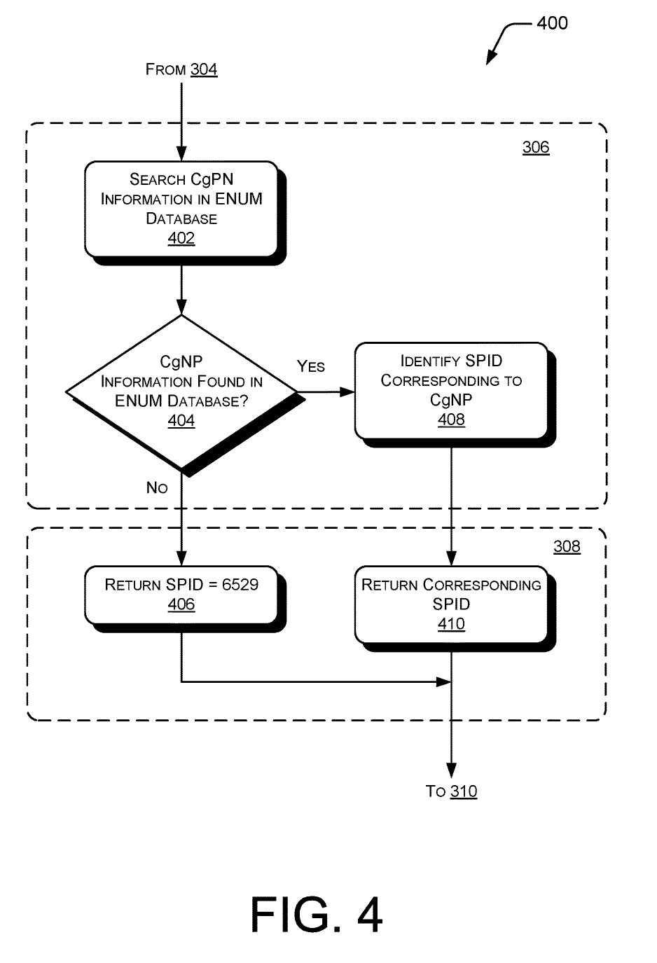

FIG. 4 illustrates an example process 400 detailing blocks 306 and 308 of FIG. 3. In block 402, the CgPN information, such as the originating phone number of the inbound call, is searched in the ENUM database 114. If the CgPN information of the inbound call is not found in the ENUM database 114 in block 404, the inbound call may be presumed to be a normal call and a corresponding SPID, such as 6529, may be returned in block 406, and the process may advance to block 310. However, if the CgPN information of the inbound call were found in the ENUM database 114 in block 404, then a fake SPID corresponding to the CgPN information, as discussed above with reference to FIG. 2, may be identified in 408. The corresponding SPID may be returned in block 410, and the process may advance to block 310.

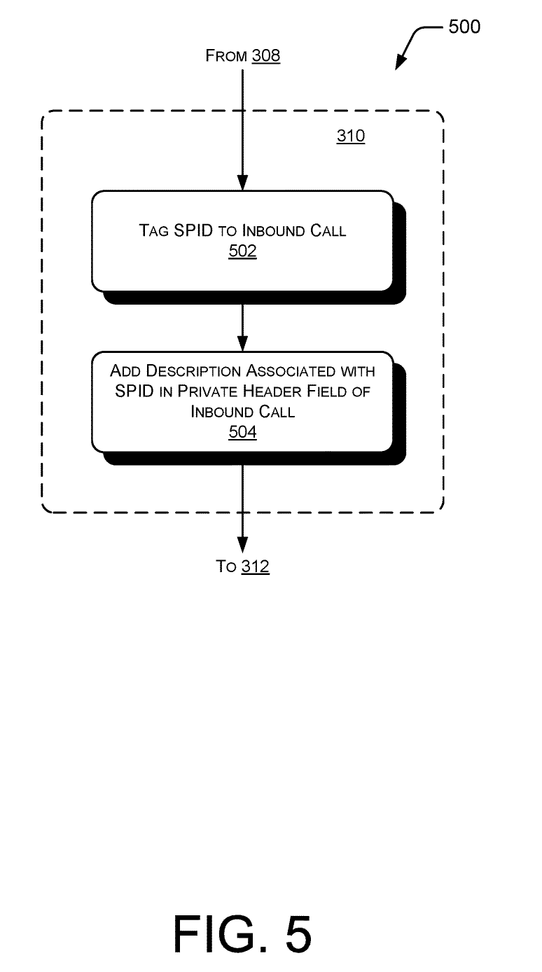

FIG. 5 illustrates an example process 500 detailing block 310 of FIG. 3. In block 502, the SPID may be tagged to the inbound call, and a description associated with the SPID may be added in a private header field of the inbound call by utilizing the HMR in block 504. The description may be designed to be visible at the called party of the inbound call and to serve as a notice or warning for the recipient of the inbound call.

Referring back to FIG. 3, the predefined process associated with the SPID in block 312 for routing the inbound call may comprise various options or alternatives. For example, an inbound call being identified as a normal call, having the SPID of 6529 as discussed above, may be routed to the recipient identified in the inbound call without further input from the I-SBC 108. In contrast, an inbound call being identified as a known SPAM, having the SPID of 9999 as discussed above, may be blocked without being routed any further, be responded back to the calling party with a predetermined message, such as undeliverable, unavailable, or error, or be automatically sent to a voicemail.

Services associated with the disclosure above may be available by subscription to customers of a service provider offering the services. Depending on a subscription level, a subscriber may receive all incoming calls without additional information, with modified caller-ID information, or with calling party information in addition to the caller-ID. The service may be customizable such that the subscriber may be allowed to determine how a certain class of calls are routed. For example, the subscriber may desire to block all calls identified as known SPAM, and to send to voicemail all call known to be market research. The subscriber may also be able to modify his blocking and routing preferences by a phone application.

Alternatively, a database, similar to the ENUM database 114 that categorizes inbound calls into categories with associated description, may be loaded into a user device as a phone application, and be maintained by the network or a third party. The phone application may allow the user to customize how calls in a certain category may be processed at the phone.

Some or all operations of the methods described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1-5. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for classifying an inbound call comprising:
detecting an inbound call;
generating a query associated with the inbound call;
identifying the inbound call based on the query and an E.164 Number to URI Mapping (ENUM) database;
tagging a service provider identification (SPID) to the inbound call based on the identification of the inbound call; and
routing the inbound call based on the SPID.

2. A method of claim 1, wherein the query associated with the inbound call comprises:
a called party number (CdPN) query and a calling party number (CgPN) query associated with the inbound call, or
a concatenated query of the CdPN query and the CgPN query associated with the inbound call.

3. A method of claim 2, wherein identifying the inbound call based on the query and the ENUM database comprises:
looking up E.164 information of the inbound call in the ENUM database based on the CgPN query;
identifying the E.164 information as one of listings in a particular classification of a plurality of predefined classifications; and
returning a SPID associated with the particular classification.

4. A method of claim 3,
wherein tagging the SPID to the inbound call based on the identification of the inbound call further comprises adding a predetermined description associated with the SPID in a private header field of the inbound call, and
wherein routing the inbound call based on the SPID comprises routing the inbound call to a called party of the inbound call having the predetermined description being visible at the called party.

5. A method of claim 4, wherein adding the predetermined description associated with the SPID in the private header field of the inbound call by utilizing a header modification rule (HMR).

6. A method of claim 3, wherein routing the inbound call based on the SPID comprises:
refraining from routing the inbound call to a called party of the inbound call based on the SPID of the inbound call; and
sending, to a calling party of the inbound call, a response indicative of the called party being unavailable.

7. A method of claim 2,
wherein identifying the inbound call based on the query and the ENUM database comprises:
looking up E.164 information of the inbound call in the ENUM database based on the CgPN query;
failing to find the E.164 information in the ENUM database; and
returning a SPID associated with the E.164 information being unavailable in the ENUM database; and
wherein routing the inbound call based on the SPID comprises routing the inbound call to a called party of the incoming call.

8. A non-transitory computer storage medium storing computer-readable instructions executable by a computer, that when executed by the computer, cause the computer to perform operations comprising:
detecting an inbound call;
generating a query associated with the inbound call;
identifying the inbound call based on the query and an E.164 Number to URI Mapping (ENUM) database;
tagging a service provider identification (SPID) to the inbound call based on the identification of the inbound call; and
routing the inbound call based on the SPID.

9. A non-transitory computer storage medium of claim 8, wherein the query associated with the inbound call comprises:
a called party number (CdPN) query and a calling party number (CgPN) query associated with the inbound call, or
a concatenated query of the CdPN query and the CgPN query associated with the inbound call.

10. A non-transitory computer storage medium of claim 9, wherein identifying the inbound call based on the query and the ENUM database maintained comprises:
looking up E.164 information of the inbound call in the ENUM database based on the CgPN query;
identifying the E.164 information as one of listings in a particular classification of a plurality of predefined classifications; and
returning a SPID associated with the particular classification.

11. A non-transitory computer storage medium of claim 10,
wherein tagging the SPID to the inbound call based on the identification of the inbound call includes adding a predetermined description associated with the SPID in a private header field, and
wherein routing the inbound call based on the SPID comprises routing the inbound call to a called party of the inbound call with the predetermined description being visible at the called party.

12. A non-transitory computer storage medium of claim 11, wherein adding the predetermined description associated with the SPID in the private header field of the inbound call by utilizing a header modification rule (HMR).

13. A non-transitory computer storage medium of claim 10, wherein routing the inbound call based on the SPID comprises:
refraining from routing the inbound call to a called party of the inbound call based on the SPID of the inbound call; and
sending, to a calling party of the inbound call, a response indicative of the called party being unavailable.

14. A non-transitory computer storage medium of claim 9,
wherein identifying the inbound call based on the query and the ENUM database comprises:
looking up E.164 information of the inbound call in the ENUM database based on the CgPN query;
failing to find the E.164 information in the ENUM database; and
returning a SPID associated with the E.164 information unavailable in the ENUM database, and
wherein routing the inbound call based on the SPID comprises routing the inbound call to a called party of the incoming call.

15. A system configured to classify an inbound call, the system comprising:
an E.164 Number to URI Mapping (ENUM) database, the ENUM database comprising:
a plurality of predefined classifications, each of the plurality of predefined classification having a corresponding service provider identification (SPID) and having a list of associated E.164 information, and
an interconnect session border controller (I-SBC) communicatively coupled to the ENUM database, the I-SBC configured to:
receive an inbound call;
generate a query associated with the inbound call upon receiving the inbound call,
determine a SPID associated with the inbound call based on the query and the ENUM database,
tag the SPID to the inbound call, and
route the inbound call based on the SPID.

16. A system of claim 15, wherein the query associated with the inbound call comprises:
a called party number (CdPN) query and a calling party number (CgPN) query associated with the inbound call, or
a concatenated query of the CdPN query and the CgPN query associated with the inbound call.

17. A system of claim 16, wherein the I-SBC is further configured to:
look up E.164 information of the inbound call in the ENUM database based on the CgPN query;
identify the E.164 information in a particular classification; and
return a SPID associated with the particular classification to the I-SBC.

18. A system of claim 17, wherein the I-SBC is further configured to:
add a predetermined description associated with the SPID in a private header field of the inbound call by utilizing a header modification rule (HMR); and
route the inbound call to a called party of the inbound call with the predetermined description being visible at the called party.

19. A system of claim 17, wherein the I-SBC is further configured to:
refrain from routing the inbound call to a called party of the inbound call based on the SPID of the inbound call; and
send, to a calling party of the inbound call, a response indicative of the called party of the inbound call being unavailable.

20. A system of claim 16,
wherein the I-SBC is further configured to:
look up E.164 information of the inbound call in the ENUM database based on the CgPN query; and
if no E.164 information of the inbound call is found in the ENUM database, return a SPID associated with the E.164 information being unavailable in the ENUM database; and
wherein routing the inbound call based on the SPID comprises routing the inbound call to a called party of the inbound call.
